(19) United States
(12) Patent Application Publication
(10) Pub. No.: US 2012/0023939 A1
(43) Pub. Date: Feb. 2, 2012

(54) Turbo compound system for a drive apparatus

(76) Inventors: Markus Kley, Ellwangen (DE); Thomas Figler, Bochum (DE); Alexander Wunsch, Heidenheim (DE)

(21) Appl. No.: 13/138,369

(22) PCT Filed: Jul. 15, 2010
(86) PCT No.: PCT/EP2010/004307

§ 371 Date: Oct. 17, 2011

(30) Foreign Application Priority Data
Jul. 22, 2009 (DE) 10 2009 034 193.5

(51) Int. Cl. F02B 41/10

(52) U.S. Cl. 60/624

(57) ABSTRACT

An apparatus comprising a turbocompound system for an internal combustion engine comprises a shaft driven by a turbine, an output shaft and a transmission unit connecting the shaft. The transmission unit is arranged in a housing and comprises at least one hydrodynamic coupling. The drive apparatus is provided in accordance with the invention with at least one conveying means, by means of which lubricating oil or a mixture containing lubricating oil can be extracted by suction from the housing.

The invention relates to a turbocompound system for a drive apparatus comprising an internal combustion engine, according to the type as specified in closer detail in the preamble of claim 1.

Turbocompound systems are known from the general state of the art. Conventional turbocompound systems comprise a turbine which is driven by an exhaust gas stream of an internal combustion engine. The power applied to a shaft driven by the turbine is typically transferred via a transmission unit with a hydrodynamic coupling to an output shaft of the turbocompound system. The transmission unit is used for reducing the very high speed of the shaft driven by the turbine to a considerably lower speed on the output shaft of the turbocompound system. The flow coupling can then be used for a purposeful transfer of the power by the turbocompound system. In addition to the controllable transfer of power, a decoupling of torsional vibrations in the shaft driven by the turbine is achieved by the hydrodynamic coupling, which torsional vibrations are present in the region of an output shaft of the internal combustion engine and which can be transferred onto the output shaft of the turbocompound system under action of the turbocompound system on the crankshaft of the internal combustion engine.

The shaft which is driven by the turbine supplies power which is taken from the exhaust gas stream of the internal combustion engine. This power then reaches the output shaft of the turbocompound system via the transmission unit. The power then reaches the region of a unit to be driven or the region of the output shaft of the drive apparatus or the crankshaft of the internal combustion engine from the output shaft in order to reduce the drive power required by the internal combustion engine. Such turbocompound systems can be arranged as the sole means for reclaiming power from the exhaust gas of an internal combustion engine, or they can be arranged in addition to further means such as a turbocharger in the exhaust train of the internal combustion engine. Typical applications for such turbocompound systems are currently especially used in commercial vehicles, buses, or tracked vehicles.

Reference is hereby made to DE 601 07 599 T2 by way of example concerning such a turbocompound system. In order to respectively lubricate the components in the transmission unit, and especially the bearing of the shaft driven by the turbine, lubricating oil can be introduced in the region of the transmission unit. The lubricating oil supply of the internal combustion engine is typically used for this purpose, which in addition to the supply of the internal combustion engine also assumes the supply of the turbocompound system with lubricating oil. DE 601 07 599 T2 describes in this connection that there are problems with respect to a lubricating oil mist in the transmission unit because it especially influences the hydrodynamic coupling in a negative way. It therefore proposes a separating wall between the individual regions of the transmission unit, which makes this configuration complex and expensive and requires a comparatively large amount of space.

It has also been noticed in addition that an oil sump can accumulate in the housing of the transmission unit of the turbocompound system which can lead to splashing losses of the components of the transmission unit and the hydrodynamic coupling. Since the supply with lubricating oil generally occurs by the lubricating oil supply of the internal combustion engine, there will be a lack of data on the oil level in the housing of the transmission unit of the turbocompound system, so that the splashing losses will occur in an uncontrolled manner from time to time whenever a respectively large quantity of lubricating oil has accumulated in the housing of the transmission unit of the turbocompound system. A principally possible configuration with a comparatively large space beneath the hydrodynamic coupling and/or the other rotating elements in the transmission unit in order to accommodate the oil sump without any negative influence on the elements in the housing of the transmission unit of the turbocompound system would require a very large amount of space and would make the turbocompound system exceptionally large and bulky, which would represent a serious disadvantage with respect to the usually required rather low overall volume for such a turbocompound system.

It is therefore the object of the present invention to avoid the aforementioned disadvantages and to provide a compact and highly efficient turbocompound system.

This object is achieved in accordance with the invention by the features mentioned in the characterizing part of claim 1.

Since the drive apparatus comprises at least one conveying means, by means of which lubricating oil or a mixture containing lubricating oil can be extracted from the housing by suction, it can be ensured that no unnecessarily large quantities of lubricating oil and/or a mixture containing lubricating oil such as a lubricating oil mist is disposed in the housing of the transmission unit of the turbocompound system. It is thereby ensured that in the bottom part of the housing of the transmission unit which is the lower part of said housing in the direction of gravity when used as intended it is not possible that such a large quantity of lubricating oil can accumulate so that components of the transmission unit, and especially the hydrodynamic coupling in this case, will splash in this oil and will therefore produce respective splashing losses. As a result of this configuration in accordance with the invention, it is therefore possible with a minimum need of overall space to provide the best possible operating conditions for the transmission unit of the turbocompound system, so that a respective increase in efficiency can be realized in the utilization of the energy from the exhaust gas of the internal combustion engine.

According to a highly advantageous and appropriate embodiment of the invention it is provided that the at least one conveying means is connected directly or via a conduit element with the housing of the transmission unit.

Depending on the available overall space, the arrangement of the turbocompound system in the drive apparatus together with the conveying means can be varied accordingly because it is possible to provide both a direct connection and installation of the conveying means in the housing of the transmission unit, and also a connection via the conduit element so that the conveying means can be arranged in a spatially distanced way from the arrangement of the housing of the transmission unit.

In accordance with a highly favorable and advantageous embodiment thereof it is also provided that the connection, when used as intended, will open in the direction of gravity above a region of the housing which typically comprises the oil sump of the transmission unit.

It is ensured by way of such an optional, alternative or supplementary configuration that the quantity of the mixture of air and oil or the lubricating oil mist disposed in the housing of the transmission unit is reduced accordingly. Furthermore, an increase in the efficiency in the power transmission in the transmission unit was observed in combination with a slight evacuation of the housing by the extraction of the lubricating almost by suction. In order to enable such an extraction by suction of a mixture containing lubricating oil or a lubricating oil mist in practice, the conveying means is advantageously arranged accordingly, so that it is able to convey gas or a gas-fluid mixture in addition to fluid.

According to an alternative or optionally also supplementary embodiment thereof it is provided that the connection opens into the housing from below in the direction of gravity when used as intended. Below shall mean in a bottom region, e.g. the bottom third of the housing, especially in the region of a bottom wall or directly in the bottom wall, advantageously opening from below, so that the opening faces upwardly.

This configuration then allows the extraction by suction of the fluid lubricating oil and, if so permitted by the conveying means, also the extraction by suction of the mentioned lubricating oil mist plus a portion of the air disposed in the housing of the transmission unit, so that the increases in efficiency as described above concerning the reduction of the fluid lubricating oil and a minimization of the splashing losses can be achieved, as also an optimization of the efficiency by the extraction by suction of the lubricating oil mist and the application of a negative pressure to the housing of the transmission unit.

It can be provided according to an especially appropriate and advantageous further development of the invention that the internal combustion engine comprises a crankcase, with at least one conveying means being arranged in the region of the crankcase by means of which lubricating oil can be extracted by suction from the region of the crankcase.

The crankcase of the internal combustion engine will generally comprise a conveying means for the lubricating oil collecting in the lubricating oil sump of the crankcase anyway. This conveying means is required in order to ensure a lubricating oil flow for the lubricating the internal combustion engine, especially its bearings and/or pistons. The conveying means therefore produces a lubricating oil circuit from the lubricating oil sump to the regions to be lubricated and back to the sump.

In addition to the lubricating oil circuit of the internal combustion engine it is possible to provide one or several further lubricating oil circuits, e.g. in order to lubricate components of a change-speed gear. This change-speed gear is typically arranged between the internal combustion engine and the driven object such as at least one driven wheel of a vehicle and can be arranged as a manually shifted transmission, an automatic or semi-automatic transmission. A conveying means is generally also provided for forming a lubricating oil circuit in this (main) transmission in order to convey lubricating oil from the lubricating oil sump. The lubricating oil circuit of the main transmission and the lubricating oil circuit of the internal combustion engine can be arranged separately or, especially with a single conveying means, in an integrated way. Further respective lubricating circuits are possible.

According to one embodiment of the invention, the lubricating oil reaches the transmission unit of the turbocompound system from the lubricating oil circuit of the internal combustion engine and/or the main transmission. It lubricates the components disposed in the transmission unit before it returns to the lubricating oil sump of the crankcase and/or the housing of the main transmission.

It is now provided according to an especially appropriate embodiment that the conveying means is arranged as the only conveying means in the region of the crankcase and/or the housing of the main transmission, with the housing of the transmission unit being connected by a conduit element with the conveying means in the region of the crankcase and/or the main transmission housing.

As a result, the lubricating oil pump which is typically present in the drive apparatus anyway can be used in order to additionally extract the lubricating oil by suction from the region of the transmission unit of the turbocompound system. The configuration will thus become very simple and compact and it is possible to omit additional components.

According to a highly advantageous and appropriate further development thereof it is further provided that the conduit element comprises a valve device which is controlled by way of a sensor and which releases a flowable cross-section of the conduit element only in the presence of fluid lubricating oil.

It is thereby ensured that only fluid lubricating oil will reach the crankcase and/or the main transmission housing in the region of the conveying means. As a result, the conventional configuration can further be used, in which a simple lubricating oil pump is used as a conveying means which is suitable only for conveying lubricating oil and not for conveying a lubricating oil-air mixture or lubricating oil mist. Although the especially simple and compact configuration which does not need any additions over the state of the art apart from the conduit element with the valve device cannot realize both of the above mentioned advantages, it can at least prevent the splashing losses occurring in the transmission unit of the turbocompound system in a very simple, cost-effective and efficient manner at least by extracting the oil by suction.

Further advantageous embodiments of the turbocompound system in accordance with the invention for a drive apparatus are provided from the remaining dependent claims and from the embodiment which will be explained below in closer detail by reference to a drawing.

The only enclosed drawing shows a drive apparatus with a turbocompound system which shows different possibilities for the configuration of the invention.

The only enclosed drawing shows a drive apparatus 1 with a symbolically indicated internal combustion engine 2. The internal combustion engine 2 can especially concern a diesel engine which is conventionally used in commercial vehicles or light rail vehicles which are the preferred vehicles for use of such a drive apparatus 1. The exhaust gas of the internal combustion engine 2 reaches the region of a turbine 4 by way of a respective exhaust gas system which is merely indicated here symbolically by the arrow 3, in which the energy contained in the exhaust gas of the internal combustion engine 3 is reclaimed. A highly schematically indicated turbocompound system 5 is used for this purpose. It comprises an output shaft 7 and a transmission unit 8 in addition to a shaft 6 which is driven by the turbine 4, which transmission unit is arranged in the housing 9 and comprises a hydrodynamic coupling or hydraulic coupling 10 in addition to suitable gear means for gear reduction of the speed of the shaft 6 driven by the turbine 4, which in this case is shown by way of example as a spur wheel gearing. The power which is reclaimed from the exhaust gas system 3 of the internal combustion engine 2 is transferred via the output shaft 7 of the turbocompound system 5 either directly or indirectly (as indicated here by way of example) via a further spur gear, which obviously also could be positioned within the housing 9 of the transmission unit 8, onto a shaft 11 of the drive apparatus 1 or the crankshaft of the internal combustion engine 2.

The power thus reclaimed then reaches the region of the actual power take-off of the drive apparatus 1 together with the power of the internal combustion engine 2 via a transmission 12. This power take-off, which is indicated here symbolically by a flange 13, can then drive the driven wheel or wheels of a vehicle which is equipped with the drive apparatus 1. The transmission 12 can typically be arranged as a gear change transmission, i.e. either as a manual gearbox or as an automatic transmission with or without a hydrodynamic converter. Moreover, an optional clutch 14 can be arranged in the shaft 11 which connects the transmission 12 with the internal combustion engine 2.

The internal combustion engine 2 comprises a crankcase 15 in the known manner. In the crankcase 15, lubricating oil accumulates in a lubricating oil sump 16 in the usual manner in the bottom region of the crankcase 15. The lubricating oil of this lubricating oil sump 16 is extracted by suction by a conveying means 17, which in this case is a lubricating oil pump 17, from the region of the lubricating oil sump 16, as is also the case in conventional configurations of the drive apparatus 1, and is supplied to the internal combustion engine 2 for the lubrication of the same. In addition, it is also supplied to the region of the transmission unit 8 of the turbocompound system 5, e.g. by way of a passage in the region of the connection of the housing 9 of the transmission unit 8 to the housing (crankcase 15) of the internal combustion engine 2 (not shown). It assumes the lubrication of the respective transmission and bearing components at that location, as also in the region of the internal combustion engine 2. Thereafter, the lubricating oil in the crankcase 15 of the internal combustion engine 2 directly reaches the region of the lubricating oil sump 16 again as a result of the action of gravity. The lubricating oil from the region of the transmission unit 8 or the housing 9 then also accumulates in the region of the housing 9 and reaches the region of the lubricating oil sump 16 from there too. For this purpose, a first conduit element 18 can be provided between the transmission unit 8 and the crankcase 15 in order to discharge lubricating oil accumulating in the region of the housing 9 of the transmission 8 in the direction towards the lubricating oil sump 16. It is understood that the transmission 12 can also be integrated in the lubricating oil circuit, or it can have a separate respective lubricating oil circuit, especially with an own conveying means/own lubricating oil pump. An illustration of this lubrication of the transmission 12 was omitted in order to simplify the illustration of the drawing.

The experience with such turbocompound systems 5 has shown that the lubricating oil quantity accumulating in the housing 9 of the transmission unit 8 cannot be influenced or can only be influenced indirectly because it typically reaches the region of the housing 9 from the region of the internal combustion engine 2. If a respectively large lubricating oil quantity accumulates in the bottom region of the housing 9, splashing losses occur in the transmission unit 8 by the hydraulic coupling 10 and/or splashing transmission means such as gearwheels for example. In order to make do with a very compact configuration of the turbocompound system 5, i.e. especially the smallest possible housing 9 of the transmission unit 8, and to avoid splashing losses to the highest possible extent, a conveying means 19 is arranged in the region of the first power element 18 in order to actively extract the lubricating oil by suction from the region of the housing 9. As a result of this active extraction by suction of the lubricating oil it is prevented that a lubricating oil sump or a too large lubricating oil sump is formed in the housing 9 which would cause respective splashing losses.

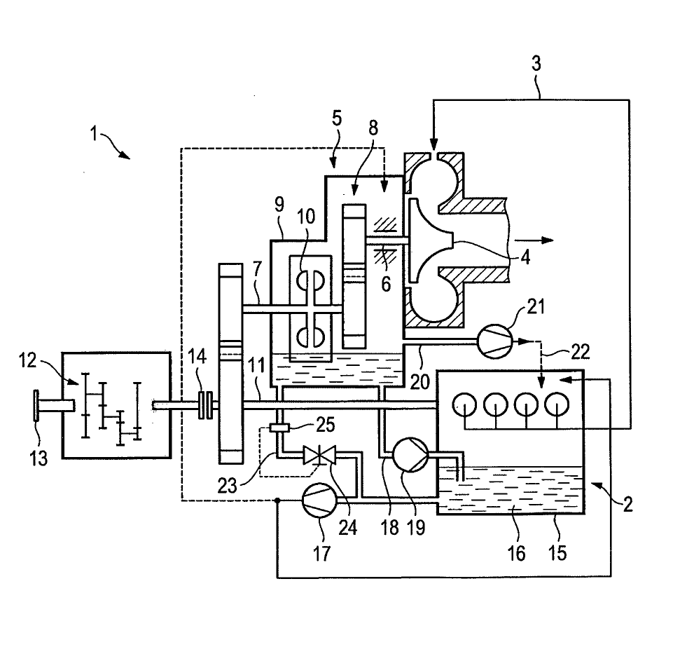

A strong turbulence of the lubricating oil will typically occur in the housing 9 as a result of the rapidly running shaft 6 which is driven by the turbine 4, so that a mist consisting of air and lubricating oil droplets that are finely distributed therein will be present virtually everywhere in the housing 9. In the case of a respective configuration of the conveying means 19, so that it is capable of extracting by suction not only fluid lubricating oil but also such a mixture of air and lubricating oil from the housing 9, it is ensured that the quantity of lubricating oil mist and lubricating oil in the housing 9 is minimized accordingly. A negative pressure is further produced in the housing 9 which is advantageously promoted by a pressure-tight sealing of the housing 9 of the transmission unit 8 towards the ambient environment. In combination with the extracted lubricating oil mist, this will reduce the losses of the partly rapidly revolving components and the hydrodynamic coupling to a considerable extent. The transmission unit 8 can therefore be relieved of excessive lubricating oil and its efficiency can be increased accordingly by the application of a negative pressure with the respective conveying means 19. The configuration shown in FIG. 1 therefore allows the minimization of power losses in the turbocompound system 5 in combination with a very compact configuration of the turbocompound system 5.

The illustration of the only enclosed drawing further shows a second conduit element 20 with a further conveying means 21. This conduit element 20 does not open into the bottom region of the housing 9, but into a region disposed slightly above the same. In normal operation, no fluid lubricating oil will presumably be extracted by suction via the conduit element 20, but merely air or a mist of air and lubricating oil droplets. The improvement in the efficiency can especially be realized by the application of a negative pressure and the extraction by suction of the lubricating oil mist via this conveying means 21. The extracted gas or the extracted lubricating oil mist can principally be supplied to any collecting container. It can also be conveyed back to the crankcase 15, as is indicated in this case by the arrow 22 shown with a broken line, so that the lubricating oil contained therein can be supplied to the lubricating oil sump 16 and thus to the lubricating oil circuit again.

It is now shown that the conveying means 19 can also realize the extraction by suction of the fluid lubricating oil from the housing 9 and also the generation of a respective negative pressure for removing by suction the lubricating oil mist. The conveying means 19 and 21 with their respective conduit elements 18 and 20 need not necessarily be provided both. It is rather sufficient if the conveying means 19 is present for example.

The illustration of the only enclosed drawing further shows that a third conduit element 23 leads from the bottom region of the housing 9 to the suction side of the conveying means 17, i.e. it leads to the lubricating oil pump. This configuration allows realizing a respective effect without any of the additional conveying means 19 or 21, because at least fluid lubricating oil can be extracted by suction from the housing 9 of the transmission unit 8 via this conduit element 23. At least the splashing losses can thereby be avoided or minimized. Depending on the type of the lubricating oil pump 17, it is also possible to apply a negative pressure to the housing 9 and the extraction by suction of air or an air-lubricating oil mist via this conduit element 23. The lubricating oil pump 17 will typically be arranged in such a way however that it is merely suitable for conveying fluid media. The inflow of a gaseous medium to the lubricating oil pump 17 can be prevented in this case via the valve device 24 which is shown here and which is controlled by way of a sensor 25. The sensor 25 controls the valve device 24 in the manner that it only releases the flowable cross-section of the conduit element 23 when there is fluid lubricating oil in the region of the sensor 25. Sensor 25 can be arranged for this purpose especially as a float or also as a capacitive filling level sensor. The triggering of the valve device 24 can therefore be realized either mechanically or electrically, depending on the type of the sensor.

Already one of the conduit elements 18, 20, 23 with the respective conveying means 19, 21, 17 is principally sufficient in order to realize an improvement of the power transfer in the transmission unit 8 of the turbocompound system 5 at least via one of the two ways as described above. It is principally also possible that all conduit elements are present with their respective devices. In order to reduce the conveying means and the conduit elements it is therefore an appropriate measure in practice to either establish a realization by way of the conduit element 18 and the conveying means 19, with the conveying means 19 then having to convey both the fluid lubricating oil and the mixture of air and lubricating oil which contains the lubricating oil.

It is especially advantageous as an alternative thereto if this conduit element 18 or at least the conveying means 19 arranged in this conduit element 18 is entirely omitted. If on the other hand the two other conduit elements 23 and 20 and the conveying means 21 are present, the extraction by suction of the fluid lubricating oil can be realized with minimum effort via the lubricating oil pump 17 by way of the conduit element 23. In addition, a respective negative pressure is applied to the housing 9 of the transmission unit 8 via the conduit element 20 and the conveying means 21 in order to extract by suction the mist of air and lubricating oil droplets and to achieve a further increase in the efficiency by the application of a negative pressure and the resulting slight evacuation of the housing 9.

All conventional and known configurations and methods are possible for driving the conveying means in the drive apparatus 1. The conveying means 17, 19, 21 can be co-driven by way of mechanical gear units, belts drives, chain drives or the like by way of rotating shafts in the drive apparatus 1, as is generally known and applied in lubricating oil pumps 17. Alternatively or in addition thereto, all or some of the conveying means 17, 19, 21 can be driven in other ways, e.g. by hydraulic or electric motors.

The turbocompound system 5 is used at least indirectly by way of its output shaft 7 to supply the power taken from the exhaust gas train 3 to the drive apparatus 1 on the output side of the internal combustion engine 2 in order to save drive power in this way. It would also be possible alternatively or in addition thereto that another component is driven by way of the turbocompound system 5, e.g. an auxiliary unit of the drive apparatus 1 or the system or vehicle equipped with the same. Such auxiliary units can be air compressors, air-conditioning compressors, hydraulic motors or the like which require a certain amount of power. The drive of such auxiliary units can especially be realized by way of the output shaft 7 of the turbocompound system 5. Other variants are principally also possible, which is the connection of such an auxiliary unit to another rotating component in the transmission unit 8 of the turbocompound system 5. The auxiliary unit can especially concern an air compressor especially in flow configuration for example which respectively compresses the air supply to the internal combustion engine 2 as an alternative or in addition to a flow compressor of a turbocharger. If it is respectively driven by way of the output shaft 7 or any other rotating component of the turbocompound system 5, it can be utilized additionally for increasing the power of the internal combustion engine 2. If such a flow compressor is realized as an auxiliary unit parallel to a connection of the turbocompound system 5 to the shaft 11 of the drive apparatus 1, a drive of such an auxiliary unit can be realized by power on the shaft 11 via the turbocompound system 5 even in the case of insufficient power in the exhaust gas train 3.

1-12. (canceled)

13. A turbocompound system for a drive apparatus comprising an internal combustion engine, comprising
a shaft driven by a turbine;
an output shaft, and
a transmission unit which connects the shafts
and which is arranged in a housing and
comprises at least one hydrodynamic coupling;
characterized in that
the drive apparatus comprises at least one conveying means, by means of which lubricating oil or a mixture containing lubricating oil can be extracted by suction from the housing.

14. The turbocompound system according to claim 13, characterized in that the at least one conveying means is connected directly or via a conduit element with the housing of the transmission unit.

15. The turbocompound system according to claim 14, characterized in that the connection, when used as intended, opens in the direction of gravity above a region of the housing typically comprising the oil sump of the transmission unit.

16. The turbocompound system according to claim 14, characterized in that the connection, when used as intended, opens in the direction of gravity into a bottom region or from below into the housing.

17. The turbocompound system according to claim 15, characterized in that the connection, when used as intended, opens in the direction of gravity into a bottom region or from below into the housing.

18. The turbocompound system according to claim 13, characterized in that the internal combustion engine comprises a crankcase, with at least one conveying means being arranged in the region of the crankcase, by means of which lubricating oil can be extracted by suction from the region of the crankcase.

19. The turbocompound system according to claim 14, characterized in that the internal combustion engine comprises a crankcase, with at least one conveying means being arranged in the region of the crankcase, by means of which lubricating oil can be extracted by suction from the region of the crankcase.

20. The turbocompound system according to claim 15, characterized in that the internal combustion engine comprises a crankcase, with at least one conveying means being arranged in the region of the crankcase, by means of which lubricating oil can be extracted by suction from the region of the crankcase.

21. The turbocompound system according to claim 16, characterized in that the internal combustion engine comprises a crankcase, with at least one conveying means being arranged in the region of the crankcase, by means of which lubricating oil can be extracted by suction from the region of the crankcase.

22. The turbocompound system according to claim 17, characterized in that the internal combustion engine comprises a crankcase, with at least one conveying means being arranged in the region of the crankcase, by means of which lubricating oil can be extracted by suction from the region of the crankcase.

23. The turbocompound system according to claim 18, characterized in that the drive apparatus comprises at least two conveying means, with one being arranged in the region of the crankcase and another being connected with the housing of the transmission unit either directly or via a conduit element.

24. The turbocompound system according to claim 19, characterized in that the drive apparatus comprises at least two conveying means, with one being arranged in the region of the crankcase and another being connected with the housing of the transmission unit either directly or via a conduit element.

25. The turbocompound system according to claim 20, characterized in that the drive apparatus comprises at least two conveying means, with one being arranged in the region of the crankcase and another being connected with the housing of the transmission unit either directly or via a conduit element.

26. The turbocompound system according to claim 21, characterized in that the drive apparatus comprises at least two conveying means, with one being arranged in the region of the crankcase and another being connected with the housing of the transmission unit either directly or via a conduit element.

27. The turbocompound system according to claim 18, characterized in that the conveying means is arranged in the region of the crankcase as the sole conveying means, with the housing of the transmission unit being connected via a conduit element with the conveying means in the region of the crankcase.

28. The turbocompound system according to claim 27, characterized in that the conduit element comprises a valve device which is controlled by a sensor and which releases a flowable cross-section of the conduit element only in the presence of fluid medium.

29. The turbocompound system according to claim 13, characterized in that the at least one conveying means is connected on the pressure side with a collecting container, especially the crankcase.

30. The turbocompound system according to claim 13, characterized in that the mixture containing lubricating oil has at least one gaseous component.

31. The turbocompound system according to claim 13, characterized in that the output shaft is connected at least indirectly with a shaft, especially the crankshaft, of the drive apparatus.

32. The turbocompound system according to claim 13, characterized in that the output shaft or any other rotating component of the transmission unit is connected at least indirectly with a drive shaft of at least one auxiliary unit.
